(19) United States
(12) Patent Application Publication
(10) Pub. No.: US 2025/0099981 A1
(43) Pub. Date: Mar. 27, 2025

(54) CENTRIFUGE ROTOR AND CENTRIFUGE

(71) Applicant: Sigma Laborzentrifugen GmbH, Osterode (DE)

(72) Inventor: Fabian Bittner, Hardegsen (DE)

(73) Assignee: Sigma Laborzentrifugen GmbH, Osterode (DE)

(21) Appl. No.: 18/977,554

(22) Filed: Dec. 11, 2024

Related U.S. Application Data
(63) Continuation of application No. PCT/EP2023/068588, filed on Jul. 5, 2023.

(30) Foreign Application Priority Data
Jul. 13, 2022 (EP) 22 184 783.3

(51) Int. Cl. B04B 7/06; B04B 7/08; B04B 9/14

(52) U.S. Cl. CPC B04B 7/06; B04B 7/08; B04B 9/146

(57) ABSTRACT

The invention relates to a centrifuge rotor with two centrifuge rotor parts. In the assembled state, the centrifuge rotor parts delimit an inner chamber in which a product to be centrifuged can be arranged. According to various embodiments, the centrifuge rotor parts are connected to each other or can be connected to each other by a locking device. The locking device is actuated and/or is biased towards a locking position by means of a centrifugal force as a result of the rotation of the centrifuge rotor.

### CROSS REFERENCE TO RELATED APPLICATIONS

This application is a continuation of International Application No. PCT/EP2023/068588 with an international filing date of Jul. 5, 2023 and claiming priority to co-pending European Patent Application No. EP 22 184 783.3 entitled “Zentrifugenrotor und Zentrifuge”, filed on Jul. 13, 2022, the disclosures of which are hereby incorporated herein by reference in their entirety.

### FIELD OF THE INVENTION

The invention relates to a centrifuge which is, for example, a laboratory centrifuge such as those distributed by the applicant (see also www.sigma-zentrifugen.de/de/products/centrifuges; date of inspection: 12.07.2022). These or other centrifuges can be used in biotechnology, in the life science sector, in the medical sector, in the pharmaceutical sector, in clinics, for blood banks, in the petroleum industry, in chemistry, for testing water or environmental media, in food technology and/or nanotechnology, to name just a few non-limiting examples.

The invention also relates to a centrifuge rotor used in such a centrifuge. The centrifuge rotor is rotated about a rotor axis to bring about the centrifugation effect, whereby this rotor axis can be oriented horizontally, vertically or at any desired inclination. The centrifuge rotor can have two centrifuge rotor parts that can be mounted to each other and, when mounted, define an inner chamber. The centrifuge rotor parts can be, for example, a base part and a cover part or two centrifuge rotor halves having the same or different designs. The medium to be centrifuged can then be arranged directly in the inner chamber, for example in a single centrifugation chamber or one of several centrifugation chambers, or in a container arranged in the inner chamber or arranged in the at least one centrifugation chamber. By means of the centrifuge, the centrifuge rotor is rotated, for example, at speeds of at least 2,000 rpm, at least 4,000 rpm, at least 7,000 rpm, at least 10,000 rpm, at least 12,000 rpm or even at least 15,000 rpm in order to bring about the centrifugation effect.

It is possible for the centrifuge rotor to be filled with the medium to be centrifuged when the centrifuge rotor is at a standstill and the two centrifuge rotor parts are dismantled from each other. However, the invention can also be used for a centrifuge rotor of a passing flow centrifuge. In such passing flow centrifuges, a medium can be fed at least temporarily to a centrifugation chamber while the centrifugation chamber is rotating and/or a medium can be discharged from the centrifugation chamber while the centrifugation chamber is rotating. The medium to be centrifuged can be, for example, a rinsing liquid, a wash or buffer solution, a modified medium extracted from the centrifuged medium and/or a sediment in the centrifugation chamber. Such a passing flow centrifuge can be, for example, a blood centrifuge in which the medium to be centrifuged is blood and the extracted modified medium or the sediment are blood cells or particles, or a passing flow centrifuge by means of which cells, microcarriers or other particles contained in the medium are to be obtained from a medium. A passing flow centrifuge can be used for the production of biopharmaceutical products in biopharmaceutical companies or in bio-processing applications. The passing flow centrifuge can be used, for example, to obtain and/or clarify cells or microcarriers, whereby the cells obtained in this way can also be used for cell therapy. Another field of application of a passing flow centrifuge is, for example, the production of vaccines.

It is also possible that the medium to be centrifuged is not a pure liquid but a solution or suspension of particles such as cells, cell debris or cell particles, etc.

DE 16 48 969 A1 (corresponding to US patent application U.S. Pat. No. 3,465,957 A) discloses a centrifugal separator wherein a drivetrain comprises a drivetrain body. The drivetrain body forms an upwardly open accommodating chamber for a rotor in which blood to be centrifuged is arranged. If the rotor is arranged in the accommodating chamber, the accommodating chamber can be closed with a drivetrain cover. The rotor secured in this way in the accommodating chamber of the drivetrain has a tube that is closed at the bottom and is connected at the upper end to a hub of an accommodating vessel via a conical connection. The accommodating vessel forms an annular chamber surrounding the upper end of the tube. During centrifugation, a heavier phase of the blood is deposited radially on the outside of the tube, whereby a lighter phase of the blood is displaced upwards, emerges from the upper end region of the tube and enters the annular chamber as a result of the centrifugation. Once the phases of the blood have been separated as a result of centrifugation, the heavier phase can be removed from the tube, while the lighter phase can be poured out of the ring chamber of the accommodating vessel via an upper opening of the accommodating vessel. To mount the drivetrain, the drivetrain cover has three locking levers pivotably mounted on screws at a location remote from the axis of rotation, the locking levers being connected to each other via springs in such a way that they are loaded radially inwards by the springs. As a result of centrifugation, the locking levers are biased and pivoted radially outwards against the action of the springs, allowing the outer end areas of the locking levers to be locked in a groove in the drivetrain body so that the drivetrain cover is fixed to the drivetrain body during centrifugation.

EP 0 605 148 A2 (corresponding to US patent application U.S. Pat. No. 5,308,309 A) discloses a drivetrain with a chuck, via which the drivetrain can be mounted with an upwardly open trough body forming a chamber. Here, the trough body is inserted into a chuck trough. The trough body can be secured to the chuck trough by means of an elastic O-ring pressed onto a circumferential collar of the trough body from above. In this case, the O-ring can be pressed against the circumferential collar of the trough body using screws screwed to a circumferential collar of the chuck trough. Alternatively, the trough body can be secured to the chuck trough by locking levers held on the chuck trough, which are pivoted when the chuck trough rotates as a result of the centrifugal forces acting on the locking levers and which are pressed from above against the circumferential collar of the trough body, thus fixing the trough body to the chuck trough during centrifugation.

U.S. Pat. No. 330 780 A discloses a circular ring-shaped rotor. The circular ring-shaped rotor comprises three circular ring segment-shaped accommodating bodies separated from each other by wedges. The accommodating bodies comprise radial blind-hole-shaped and radially outwardly closed accommodations in which sample containers with milk or cream can be arranged. The circular ring-shaped rotor formed with the wedges and the accommodating bodies can then be inserted into a cylindrical accommodation of a drivetrain body. When the drivetrain body is rotated, the centrifugal force applied to the wedges and the accommodating bodies causes the radial distances of the wedges and the accommodating bodies from the axis of rotation to increase, whereby they are pressed against the cylindrical accommodation of the drivetrain body and the rotor is fixed to the drivetrain body during centrifugation.

DE 853 729 C discloses a centrifuge in which a lid comprises a central through-hole. A shaft extending through the central through bore concentrically to a rotor axis comprises a circumferential groove at a distance from the top of the lid. A lid closure comprises an upper part and a lower part in which locking elements are guided in a sliding manner transverse to the rotor axis. The locking elements have an elongated hole, the boundary of which forms a locking edge in one end region. The two locking elements are arranged one above the other in such a way that the elongated holes form a continuous recess through which the shaft extends. The centers of gravity of the locking elements are arranged eccentrically on opposite sides of the rotor axis in such a way that when the locking elements rotate about the rotor axis, the locking elements are acted upon radially outwards in such a way that the locking edges of the locking elements on opposite sides engage in opposite directions with the groove of the shaft, thus achieving a locked position of the lid closure. Springs act between the two locking elements to bias the locking elements towards the unlocked position. The effective centrifugal forces overcome the action of these springs to bring about the locked position.

### SUMMARY OF THE INVENTION

The invention relates to a centrifuge rotor as it can be used in the various types and designs of centrifuges mentioned at different the beginning. The centrifuge rotor can be connected to a rotor shaft of the centrifuge via a shaft-hub connection known per se.

The centrifuge rotor comprises two centrifuge rotor parts, which may be a base part and a cover part or may be two centrifuge rotor halves, to name just a few examples that do not limit the invention. The two centrifuge rotor parts can be mounted to each other. In the assembled state, the two centrifuge rotor parts together delimit an inner chamber, which is preferably done by completely closing the inner chamber and/or sealing the inner chamber. The inner chamber can be a continuous inner chamber. Preferably, the inner chamber is divided into different sub-chambers, which may be centrifugation chambers. The at least one product to be centrifuged can be arranged in the inner chamber, in particular in the centrifugation chambers, which can be done by direct arrangement in the centrifugation chamber or by arranging a container, bag or similar in the centrifugation chamber.

Conventional centrifuge rotor parts are connected to each other by means of screw connections, which ensures a reliable connection but requires careful operation of the screw connections, can be time-consuming and can make the reliability of the connection dependent on the screw torque applied to the screw connection. If the connection via the screw connection is based on the fact that a frictional or clamping force is created between the centrifuge rotor parts by means of the screw connection, there may initially be the impression that the centrifuge rotor parts are sufficiently firmly connected to each even if the tightening torque of the screw connection is insufficient. If the centrifuge rotor is then operated with a rotation of the rotor around the rotor axis, any force caused by a centrifugal force increases quadratically with the speed of the centrifuge rotor. If a centrifugal force acting on the centrifuge rotor parts and increasing with the acceleration of the centrifuge rotor exceeds the clamping or frictional force caused by the screw connection, an undesired change in the relative position of the centrifuge rotor parts occurs suddenly and unexpectedly.

In one embodiment, it is proposed that the centrifuge rotor parts are connected to each other via a locking device. This locking device can be used exclusively or in addition to another connecting device for connecting the two centrifuge rotor parts. The locking device is actuated by a centrifugal force due to the rotation of the centrifuge rotor. This leads (for a non-limiting example) to the advantage that the user only has to bring the two centrifuge rotor parts into the predetermined relative position (in particular with an abutment against each other), without the user having to actuate a connecting device at all. If the centrifuge rotor is then set in rotation, the centrifugal force resulting from the rotation of the centrifuge rotor automatically actuates the locking device, thus reliably a connection of the centrifuge rotor parts being provided. In this way, the reliable connection of the two centrifuge rotor parts can also be ensured independently of the operator's care, since the operator does not have to be careful not to forget to actuate a connecting device, but an automatic connection is provided by the actuation of the locking device by the centrifugal force. It is also possible that the locking device is biased towards a locking position by means of the centrifugal force. This variant covers embodiments in which the locking device is actuated manually, but in which the centrifugal force then biases the locking device towards the locking position during operation of the centrifuge rotor, thereby reliably ensuring that the locking position is not unintentionally left again during operation of the centrifuge rotor. One aspect comprises that the centrifugal force which acts to actuate the locking device and/or to maintain the locking position increases quadratically with an increase in the speed of the centrifuge rotor. The damage that an improper connection of the two centrifuge rotor parts can cause may increase with an increase in the speed of the centrifuge rotor. The described design can ensure that the securing effect of the connection of the two centrifuge rotor parts automatically increases with an increase in the speed of the centrifuge rotor, so that the securing effect is increased in accordance with the potentially increased damage.

In one embodiment, the locking device comprises a first locking element. The locking element comprises a locking pin. Furthermore, a second locking element is provided comprising a locking carriage and a sliding guide which guides the locking carriage for a movement from an unlocking position to a locking position as a result of the centrifugal force. In the locking position of the locking device, the first locking element and the second locking element establish a positive fit. This positive fit blocks a disassembly of the two centrifuge rotor parts. To provide the positive fit, the two locking elements form abutting contact surfaces that block a disassembly. Preferably, the contact surfaces of the locking elements block a relative movement of the two centrifuge rotor parts away from each other in the direction of the rotor axis.

It is possible, for example, that the contact surface of at least one locking element is arranged in a plane having an orientation transverse to the rotor axis or that it is oriented at an angle of inclination relative to the plane oriented transverse to the rotor axis. In the locking position of the locking elements, a frictional force can also be present between the contact surfaces. It is also possible that the frictional force (depending on any angle of inclination) leads to a certain degree of self-locking. It is also possible that an insertion aid is provided by an inclined contact surface to bring about the positive fit and the locking.

In one embodiment, the second locking element is embodied as the radially displaceable locking carriage. In the locking position, the locking carriage then interacts with a positive fit with the first locking element, namely the locking pin.

The sliding guide is used to guide the locking carriage in a radially displaceable manner. It is also possible for the locking carriage to be guided by the sliding guide only with one movement component in a radial direction and/or that sliding guide guides the locking carriage along a linear or curved degree of freedom.

The locking carriage comprises an elongated hole whose longitudinal axis is oriented in a radial direction (at least with one component of the orientation). The radially inner end area of the elongated hole can be open at the edge or closed at the edge. The locking pin of the first locking element extends through the elongated hole.

The elongated hole has two different sections, namely a locking section and an unlocking section. The width of the elongated hole is greater in the unlocking section than in the locking section. In the locking section, the locking carriage can then interact with the locking pin to bring about the locking effect, while in the unlocking section, no locking effect is brought about due to the oversize of the elongated hole here compared to the locking pin, which means that the two centrifuge rotor parts can be disassembled from each other in the unlocking section.

It is possible that the two centrifuge rotor parts are only connected to one another via one single locking device. According to a further proposal, several locking devices are provided in order to connect the centrifuge rotor parts to one another. In this case, the locking devices can be evenly distributed in the circumferential direction around a rotor axis of the centrifuge rotor and arranged at the same distances from the rotor axis. For example, the locking devices may comprise a distance from the rotor axis that is at least half the outer radius of the centrifuge rotor. If the locking devices are evenly distributed in the circumferential direction at the same distance from the rotor axis, any imbalance caused by the locking devices can at least be reduced.

To name just a few examples, the locking protrusion of the locking pin can be embodied as a nose or a step that widens the cross-section.

In one embodiment, the locking carriage is designed as an L-shaped sliding piece. Here, one leg of the L can cooperate with the sliding guide and can serve to ensure that the locking carriage is guided relative to the second centrifuge rotor part. Alternatively or cumulatively, this leg can comprise the elongated hole through which the locking pin extends. The other leg of the L can, for example, contribute to the mass for generating the centrifugal force by means of which the locking device is actuated or the locking position is maintained. Alternatively or cumulatively, this other leg of the L can serve as a manual actuation means by which the operator can act on the locking carriage to manually change its position. To mention only one non-limiting option, the first mentioned leg of the L can be received in a corresponding accommodating groove of the sliding guide similar to a dovetail guide for the purpose of forming a dovetail guide for providing the radial degree of freedom of movement of the L-shaped sliding piece.

In the locking position of the locking device, the locking elements contact each other via the contact surfaces. At least one contact surface, preferably both contact surfaces, can then be inclined relative to a plane having an orientation transverse to the rotor axis, whereby the centrifugal force acting on the locking element is then converted by the at least one contact surface into a contact force by which the centrifuge rotor parts are pressed against each other.

In one embodiment of the centrifuge rotor, it is proposed that the locking element, namely the locking carriage, comprises a manual actuation member by means of which the locking element can be moved manually from the locking position into the unlocking position and/or from the unlocking position into the locking position. After the centrifuge rotor parts have been mounted to each other, the locking device can thus be moved into the locking position via the manual actuation means, which is then maintained by the centrifugal force during operation of the centrifuge. After the centrifuge has finished operation, the operator can manually move the locking device from the locking position to the unlocking position using the manual actuation means, which then also allows the two centrifuge rotor parts to be disassembled from each other.

A securing device is provided for a further proposal. The securing device can be used to secure the locking carriage in the unlocking position and/or locking position. The securing device can, for example, be embodied as a holding, latching or locking device. The following are non-limiting examples of the use and advantages of the securing device.
It is advantageous or necessary for the assembly of the centrifuge rotor parts to each other that the locking device is in the unlocking position during the assembly process, as otherwise the assembly of the centrifuge rotor parts may be blocked by the locking elements. The locking carriage can thus be held in the unlocking position during assembly by means of the securing device. This is particularly important if, during assembly of the centrifuge rotor parts, the axis of rotation of the centrifuge rotor parts is inclined relative to the vertical axis, which can lead to the locking carriage assuming its locking position as a result of gravity. Such undesired movement of the locking carriage into the locking position can be avoided by a securing device.
Even if the centrifuge rotor parts have already been assembled to one another and the locking carriage is in the locking position, the securing device can be used to prevent the locking carriage from moving into the unlocking position undesirably, for example as a result of vibrations, of the closing of a lid of the centrifuge, of an impact on the centrifuge or the centrifuge rotor or during a transient start-up of the centrifuge.

In the event that the securing device secures an unlocking position of the locking carriage, it may be desirable for the securing device to be automatically released by a centrifugal force acting on the locking carriage when the centrifuge starts to operate. If the securing device is embodied as a type of latching connection, for example, the centrifugal force for a predetermined threshold value of the number of rotations is greater than the latching force of the latching connection, whereby the latching connection is released and the locking carriage can automatically move from the unlocking position to the locking position as a result of the centrifugal force.

For a particular proposal, the securing device is embodied as a magnetic securing device. For example, the second centrifuge rotor part or sliding guide can carry a permanent magnet which interacts with a counter-magnet of the locking carriage in such a way that the unlocking position of the locking carriage is maintained by the magnetic force. If the centrifugal force acting on the locking carriage then becomes so great that it can overcome the magnetic force, the securing device is automatically released so that the locking carriage can move from the unlocking position to the locking position as a result of the centrifugal force.

For a further proposal, the locking carriage moved as a result of the centrifugal force can be used multifunctionally by being part of a sensor. This sensor can then be used, for example, to detect the position of the locking carriage so that a control unit of the centrifuge can be supplied with the information as to whether the locking carriage is in the locking position or in the unlocking position. Alternatively or cumulatively, the sensor of the locking carriage or of the first locking element can be used to evaluate the rotational movement of the centrifuge rotor with which the locking carriage rotates. In this case, several or all components of the sensor can also be integrated into the locking device. To give just one example, one sensor element can be arranged on the first locking element and one sensor element can be arranged on the second locking element, in which case the sensor then detects the relative position of the two sensor elements. In this case, the measurement signal of the sensor (possibly also after processing and/or evaluation by a control unit also integrated in the locking device) can be transmitted to a control unit of the centrifuge by cable or wirelessly. For another example, the locking carriage or locking pin and a sensor element embodied as such or held by it can cooperate with another sensor element, which is arranged, for example, in the area of the wall of the vessel of the centrifuge or elsewhere in the centrifuge. It is then possible, for example, that at the time at which the sensor element of the locking carriage passes the sensor element of the wall of the vessel or the centrifuge, the distance between the sensor elements is used to determine whether the locking carriage is in the unlocking position or in the locking position. On the other hand, at the time at which the sensor element of the locking carriage or locking pin passes the sensor element of the wall of the vessel or centrifuge, a counting pulse can be triggered, on the basis of which the speed of the centrifuge rotor can be determined. It is also possible that the interaction of the two sensor elements is used to directly determine the circumferential speed. It is possible, for example, that a laser is integrated into the wall of the vessel or the centrifuge. If the locking element with the associated sensor element, which in this case can be formed as a reflective surface of the locking element, passes the laser, the beam of the laser is reflected by the reflective surface and the reflected beam reaches a receiver, which is also integrated into the wall of the vessel and can also be combined with the laser to form a sensor unit. Based on the reflected and received beam of the laser, the position of the locking element can then be determined from the distance between the sensor elements, which can be used to detect whether the locking element is in the unlocking position or in the locking position. Alternatively or cumulatively, the circumferential speed or rotational speed of the locking element and thus of the centrifuge rotor can be determined on the basis of the reflected and received beam of the laser by means of a triggered pulse or otherwise.

Another embodiment relates to a centrifuge (in particular a laboratory centrifuge or passing flow centrifuge) comprising a centrifuge rotor which is designed as described above. Here, the centrifuge rotor can be connected to a rotor shaft of the centrifuge via a shaft-hub connection known per se. The two centrifuge rotor parts can then be secured separately and at a radial distance from the shaft-hub connection by means of the centrifugal-force-actuated or centrifugal-force-biased locking device.

For one proposal, the centrifuge comprises a control unit equipped with control logic. An imbalance of the centrifuge rotor is determined by means of the control logic. For this purpose, the centrifuge may, for example, comprise a force or acceleration sensor that detects the imbalance of the centrifuge rotor with an evaluation of the signal from the force or acceleration sensor by the control logic. It is also possible for an imbalance to be determined on the basis of the drive signal and the required electrical load of an electric motor that is used to drive the centrifuge rotor. Based on the determined imbalance, an evaluation can then be made as to whether the locking device is properly locked. If, for example, several locking devices are used on the centrifuge rotor and if one locking device is in the unlocking position while the other locking devices are properly in the locking position, the locking device in the unlocking position will result in an imbalance. If such an imbalance is detected, the driving movement of the centrifuge rotor can be aborted, for example, an error entry can be made in a documentation database and/or a display can be generated n the centrifuge for the user indicating that the locking device is/was not properly closed. Since both the difference in the radial position of the locking element in the locking position and the unlocking position and the mass of the locking element are known, it is known a priori which imbalance will be given if one of the locking elements is not in the locking position. This means that a quantitative evaluation of the determined imbalance can also be carried out to determine how many locking elements are not in the locked position. It is also possible that, on the basis of a quantification of the imbalance, a distinction is made by the control logic as to whether the cause of the imbalance is the incorrect operating position of at least one locking device or, for example, the cause of the imbalance is an improper filling of the centrifuge rotor with the medium to be centrifuged or an improper arrangement of the containers with this medium in the centrifuge rotor.

With the above proposals it is e. g. possible that a centrifuge rotor and a centrifuge with such a centrifuge rotor are improved with respect to ensuring the reliable connection of the centrifuge rotor parts and/or simplifying the assembly and/or disassembly of the centrifuge rotor parts and/or ensuring operational safety.

Advantageous developments of the invention result from the claims, the description and the drawings.

The advantages of features and of combinations of a plurality of features mentioned in the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated geometries and the relative dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to the features of the claims, or the features of the claims may be the only features of the claimed subject.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with reference to preferred embodiments shown in the figures.

FIG. 1 shows a centrifuge rotor part of a centrifuge rotor in a three-dimensional view obliquely from above.

FIG. 2 shows a three-dimensional view obliquely from above of a centrifuge rotor with two centrifuge rotor parts mounted together with locking devices, which are in the unlocking position in the left half of the figure and which are in the locking position in the right half of the figure.

FIG. 3 shows a section along the rotor axis through the centrifuge rotor according to FIG. 2 with a section made in a sectional plane that is spanned by the rotor axis and coaxial linear guide directions of diametrically opposed locking devices.

FIG. 4 shows a top view of the centrifuge rotor as shown in FIGS. 2 and 3.

FIG. 5 shows a locking element of a locking device of the centrifuge rotor according to FIGS. 2 to 4 in a three-dimensional view.

FIG. 6 shows a three-dimensional view obliquely from above of a further embodiment of a centrifuge rotor with centrifuge rotor parts assembled to each other, wherein in the left half of the figure the locking devices are in the unlocking position and in the right half of the figure the locking devices are in the locking position.

FIG. 7 shows the centrifuge rotor according to FIG. 6 in a sectional view with a section made in a sectional plane, which is spanned by the rotor axis and coaxial linear guide directions of diametrically opposing locking devices.

FIG. 8 shows a top view of the centrifuge rotor as shown in FIGS. 6 and 7.

FIG. 9 shows a locking element of a locking device of the centrifuge rotor according to FIGS. 6 to 8 in a three-dimensional view.

### DETAILED DESCRIPTION

In the description and the patent claims, some components or features thereof which correspond or are similar in terms of design and/or function are labelled with the same reference signs, whereby these can then be labelled with the supplementary letter a, b, . . . . In this case, reference can then be made to these components or features with or without the supplementary letter, whereby one of the components or features, several or all of the components or features are then addressed. If corresponding components or features are present more than once in a figure, they can also be identified with reference signs and-lines only at one single location.

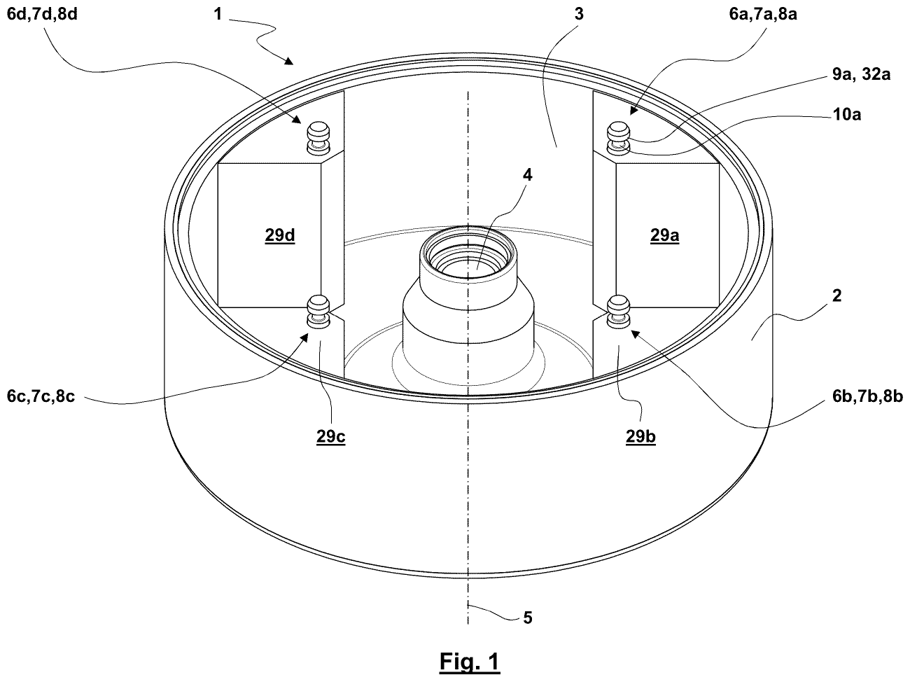

FIG. 1 shows a centrifuge rotor part 1 (here as “first centrifuge rotor part”), which may be a base part. The centrifuge rotor part 1 has an upwardly open housing 2, which defines an inner chamber 3 that is initially open at the top. In the open state according to FIG. 1, a medium to be centrifuged can be arranged in the inner chamber 3, in particular in at least one container, which in turn can also be arranged in a cage or accommodating body together with other containers.

The centrifuge rotor part 1 comprises a hub 4, by means of which the centrifuge rotor 1 can be connected to a rotor shaft of a centrifuge, not shown here, in a rotationally fixed manner. Any shaft-hub connection can be used here. Also a shaft-hub connection as described, for example, in the publication EP 3 012 027 B1 and actuated or secured by means of a centrifugal force can be used.

The centrifuge rotor part 1 comprises a rotor axis 5. If the centrifuge rotor part 1 is connected to a rotor shaft of a centrifuge via the hub 4, the centrifuge rotor part 1 can be rotated about the rotor axis 5 by driving the rotor shaft in order to achieve the desired centrifugation effect.

The centrifuge rotor part 1 has (here four) locking elements 6a, 6b, 6c, 6b evenly distributed along the circumference. The locking elements 6 are embodied as locking protrusions 7, here embodied as locking bolts 8. In the free end region, the locking elements 6 have a locking recess 9, which, when the locking elements 6 are designed as locking bolts 8, is formed as a circumferential locking groove 10, the outer boundary of which forms the locking recess 9. The locking elements 6, in this case the locking bolts 8, extend parallel to the rotor axis 5 and extend in this direction out of the centrifuge rotor part 1 (upwards in FIG. 1). In FIG. 1, the locking recess 9 and the locking groove 10 are only marked for the locking element 6a, the same applying to the locking elements 6b, 6c, 6d.

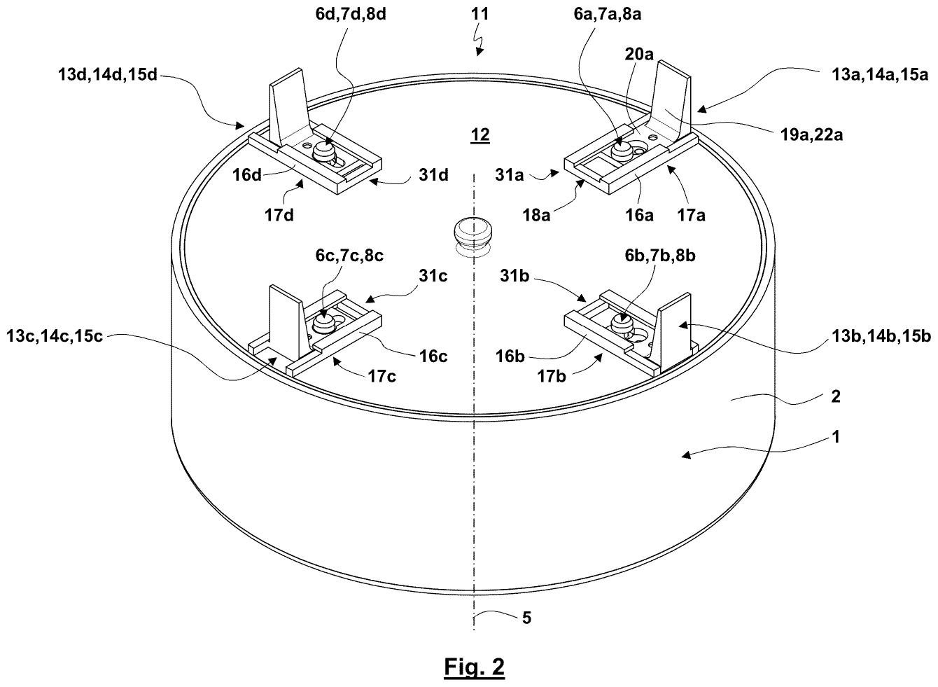

FIG. 2 shows a centrifuge rotor 11 in which the centrifuge rotor part 1 is mounted to a centrifuge rotor part 12 (here also “second centrifuge rotor part”), here a cover part, in that the centrifuge rotor part 12 is placed on the centrifuge rotor part 1 from above, the placing or mounting for joining taking place in the direction of the rotor axis 5. In the assembled state of the centrifuge rotor parts 1, 12, the inner chamber 3 is closed.

Four locking elements 13a, 13b, 13c, 13b are evenly distributed around the circumference of the centrifuge rotor part 12 and arranged at the same distances from the rotor axis 5. The positions of the locking elements 13 correspond to the positions of the locking elements 6 so that they can interact with each other.

The locking elements 13 are embodied as a locking carriage 14, in particular in the form of an L-shaped sliding piece 15. The locking carriage 14 is connected via a sliding guide 16 that is rigidly connected to the centrifuge rotor part 12 or formed by the same for providing a linear guide 17. The linear guide 17 ensures that the locking element 13 comprises only one single degree of freedom (preferably limited in both directions) having an orientation radial to the rotor axis 5. In the present case, the sliding piece 15 forms a linear guide 17 with the sliding guide 16 in the form of a dovetail guide 18.

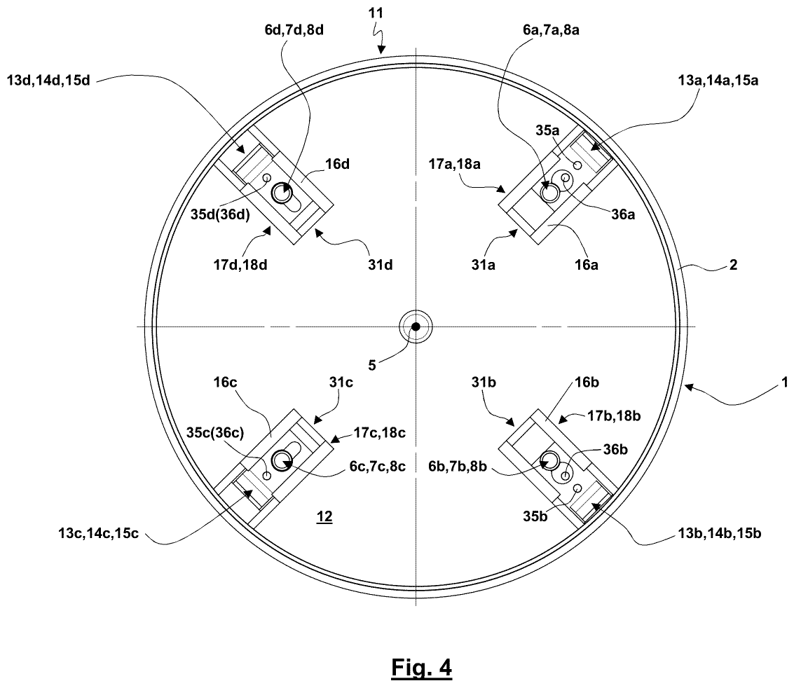

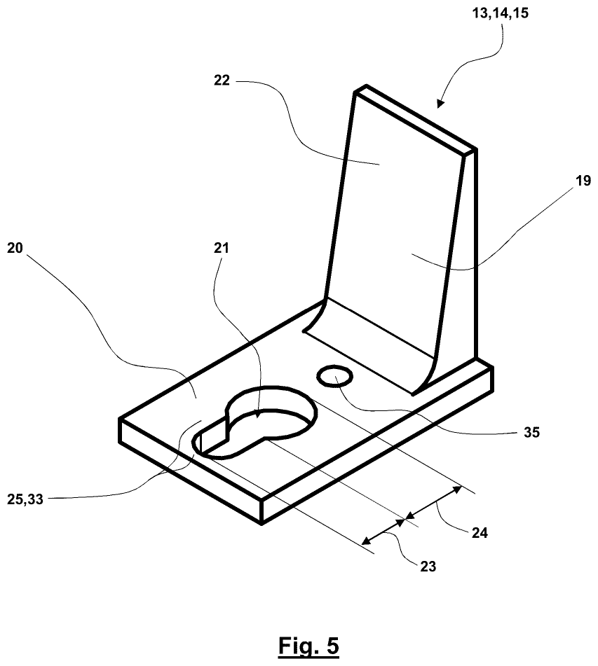

The sliding piece 15 is L-shaped with legs 19, 20 of the L oriented approximately at right angles to each other. The cross-section of the leg 20 is positively received transversely to the linear degree of freedom and guided in a correspondingly shaped guide recess of the sliding guide 16. The leg 19 extends parallel to the rotor axis 5. The operator can use the leg 19 to manually bias the locking element 13 and move it along the linear guide 17. The linear degree of freedom of the linear guide 17 is oriented radially to the rotor axis 5. The leg 19 forms a manual actuation means 22, which the operator can use to change the operating position of the locking element 13. The leg 20 comprises an elongated hole 21. For the embodiment according to FIGS. 1 to 5, the elongated hole 21 of the locking elements 13 comprises two sections, namely a locking section 23 and an unlocking section 24. In the unlocking section 24, the elongated hole 21 has a partially circular cross-section. The diameter of the partially circular shaped cross-section is slightly larger than the diameter of the locking protrusion 7, so that an end region or head 27 of the locking protrusion 7 can pass through the unlocking section 24. In the area of the locking section 23, the width of the elongated hole 21 is reduced compared to the width in the unlocking section 24 or the diameter of the unlocking section 24.

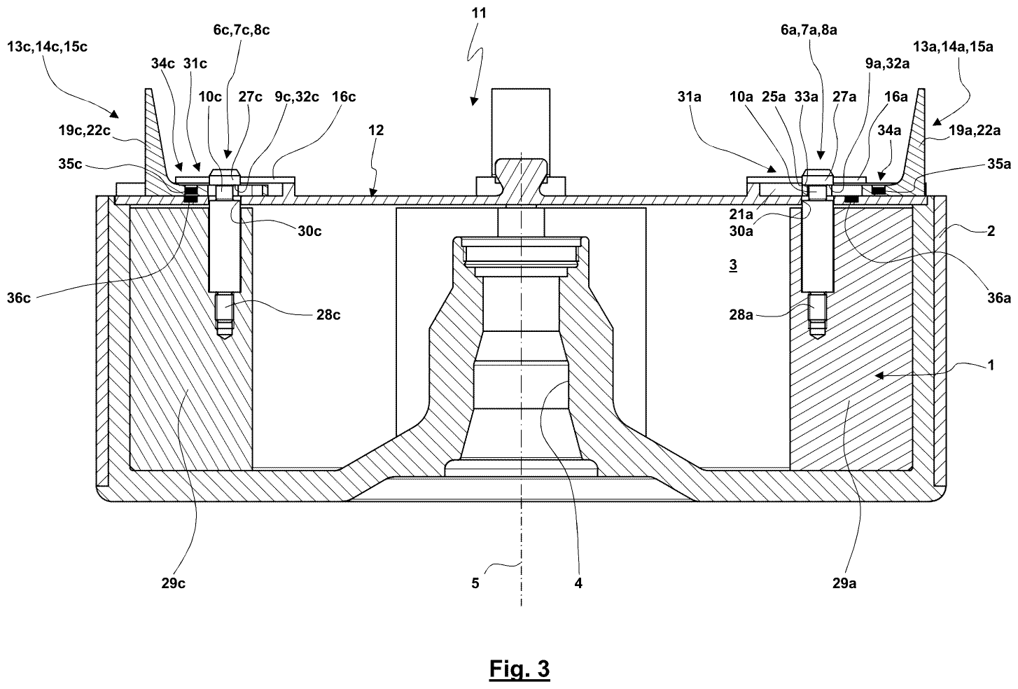

As can be seen in particular in FIG. 3, the locking protrusion 7 has a locking protrusion 25. For the design of the locking protrusion 7 as a locking bolt 8, the locking protrusion 25 is formed by the outer boundary of the circumferential locking groove 10. In this case, the diameter of the unlocking section 24 can be slightly larger than a head 27 of the locking bolt 8 above the locking groove 10, while the width of the elongated hole 21 in the locking section 23 is smaller than the width of the head 27, but slightly larger than the width of the bottom of the circumferential locking groove 10.

FIG. 3 also shows that the locking bolt 8 is embodied as a stepped bolt with a threaded section 28 at the end, in the area of which the locking bolt 8 is screwed to the centrifuge rotor part 1, in particular the housing 2 or an insert body 29. Away from the threaded section 28, the locking bolt 8 preferably has a cylindrical design (except for the locking groove 10) and is received and/or guided in a corresponding accommodation or guide bore of the centrifuge rotor part 1 or insert body 29. The locking bolt 8 protrudes upwards out of the centrifuge rotor part 1 with the upper end region, in particular the locking groove 10 and the head 27.

If the centrifuge rotor part 12 is brought closer to the centrifuge rotor part 1 for assembly with an assembly direction corresponding to the rotor axis 5, the upper end regions, in particular the head 27 and the locking groove 10, pass through a recess 30 of the centrifuge rotor part 12, so that in the assembly position sketched in FIG. 3, the locking groove 10 protrudes at least partially and the head 27 protrudes completely outwards from the centrifuge rotor part 12. During this assembly, the head 27 can also pass through the unlocking section 24 of the locking element 13. If the locking element 13 is moved radially outwards, the locking element 13 is displaced along the linear guide 17, whereby the locking bolt 8 with the locking groove 10 enters the area of the locking section 23 of the locking element 13. The end of the radial movement of the locking element 13 is set by the fact that the bottom of the locking groove 10 of the locking bolt 8 abuts the radially inner boundary of the elongate hole 21. In the locking position of the locking element 13 reached in this way, the exit of the locking bolt 8 from the locking element 13 in a disassembly direction is blocked by the fact that in the locking section 23 the head 27 rests against the lateral limitations of the elongated hole 21 from above. As a result the centrifuge rotor part 12 is trapped between on the one hand the top of the centrifuge rotor part 1 and on the other hand side the locking protrusion 25, which is provided by the locking groove 10 respectively the head 27. The assembled position of the two centrifuge rotor parts 1, 12 can thus be secured in this way. The locking elements 6, 13 form a locking device 31.

In the locking device 31, the locking elements 6, 13 contact each other with a first contact surface 32 and a second contact surface 33 to ensure the locking effect. Here, the first contact surface 32 of the locking element 6 is provided by the underside of the head 27 or the upper lateral limitation of the locking groove 10, which forms the locking recess 9. On the other hand, the second contact surface 33 of the locking element 13 is provided by the lateral edge region of the sliding piece 15, which delimits the locking section 23 of the elongated hole 21 and forms the locking protrusion 25.

In FIGS. 2, 3 and 4, the locking elements 13c, 13b are shown in the left half-space in the unlocking position, while they are shown in the right half-space in the locking position. When the centrifuge rotor 11 is at a standstill, the operator can basically bring about any desired operating position of the locking elements 13 via the manual actuating element 22. When the centrifuge rotor 11 is in operation, the locking latching elements 13 are all automatically moved into the locking position by the centrifugal force, and held in this position.

FIGS. 2 to 5 show an optional special feature: Here, the locking devices 31 each have securing devices 34. For the illustrated embodiment, each securing device 34 comprises two permanent magnets 35, 36. One permanent magnet 35 is integrated into the locking element 13, in this case into the leg 20 of the sliding piece 15, while the other permanent magnet 36 is integrated into the centrifuge rotor part 12 or the sliding guide 16. In the position to be secured by means of the securing device 34, the magnetic flux of the permanent magnets 35, 36 is directly closed, so that the opposite poles of the permanent magnets 35, 36 are arranged directly adjacent or aligned. The magnetic force between the permanent magnets 35, 36 thus maintains the secured position of the locking device 34. If the secured position is the unlocking position, the start of operation of the centrifuge with the rotation of the centrifuge rotor 11 causes the centrifugal force acting on the locking elements 13 to increase until the centrifugal force is sufficient to overcome the securing force between the permanent magnets 35, 36, in this way the secured position of the securing device 34 being left. It is to be understood that, in deviation from the illustrated embodiment, the locking position can also be secured alternatively or cumulatively, for example by a further permanent magnet arranged at the corresponding position in the area of the centrifuge rotor part 12. It is also possible that a magnetic securing device 34 is not used, but instead any other type of latching device or a frictionally engaged securing device 34 is used.

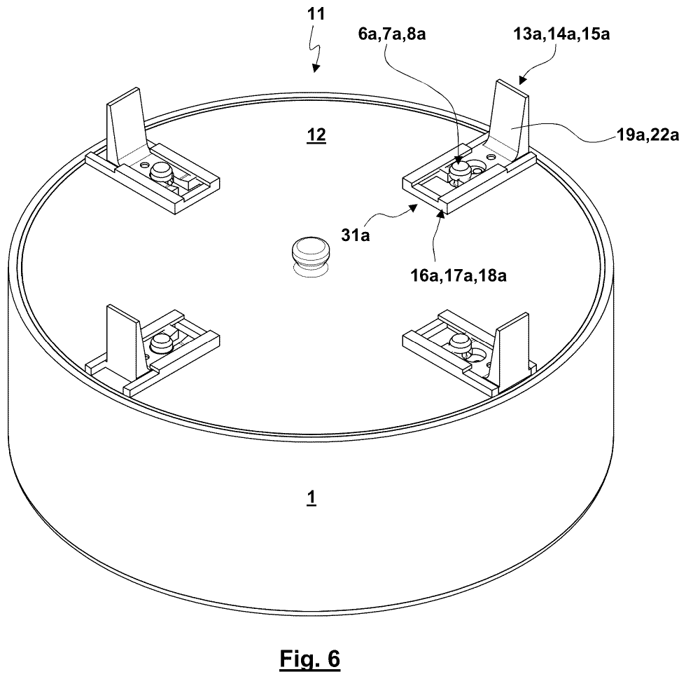

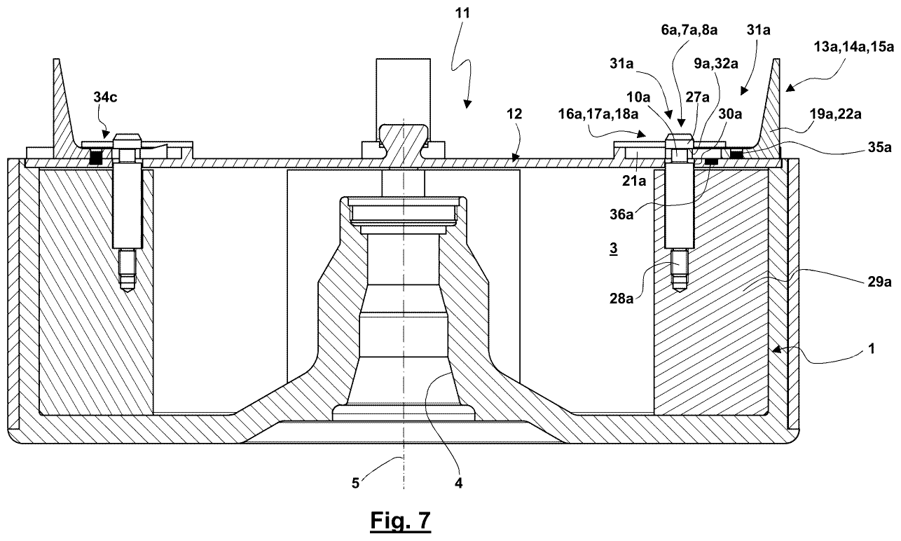

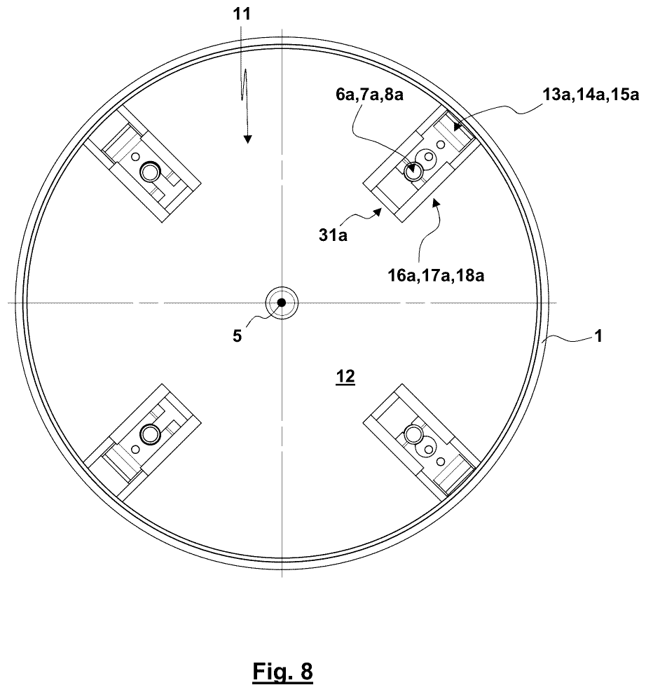

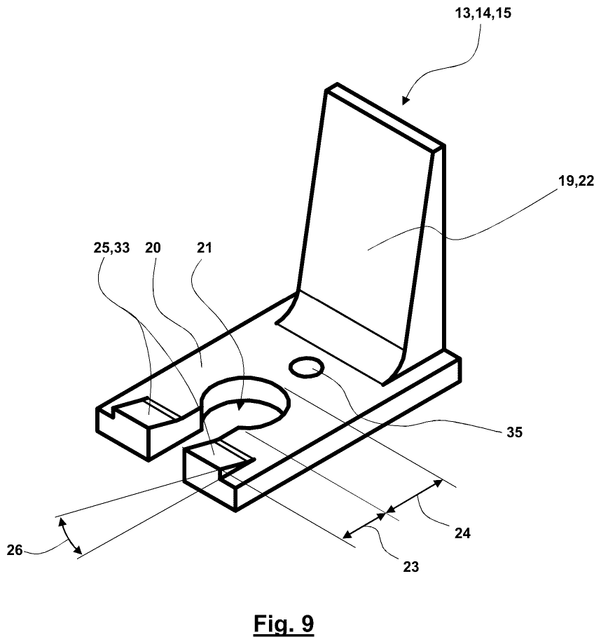

In the embodiment shown in FIGS. 6 to 9, what has been said about the embodiment according to FIGS. 1 to 5 applies accordingly until further notice. However, the locking element 13 is embodied as different here (see in particular FIG. 9). In this case, the elongated hole 21 is not closed on the radially inner side, but open (without this necessarily being the case with an otherwise corresponding design). Here, the contact surfaces 33 provided by the locking protrusion 25 of the locking element 13, with which the locking element 13 establishes a locking connection with the locking protrusion 9 of the locking element 6, are inclined with respect to the plane oriented transverse to the rotor axis 5 with an angle of inclination 26 such that the contact surface 33 rises in the direction of the rotor axis 5. If in this embodiment the locking element is moved radially outwards manually or as a result of the centrifugal force, the contact surface 33 slides along the contact surface 32 provided by the locking recess 9 of the locking element 6, namely provided by the lateral boundary of the locking groove 10 or the underside of the head 27. With continuing sliding movement, the locking element 13 is increasingly braced with the locking element 6 in the area of the contact surface 33. As a result, the centrifuge rotor parts 1, 12 are increasingly pressed against each other and the locking effect and the securing of the assembled position of the centrifuge rotor parts 1, 12 is strengthened.

Many variations and modifications may be made to the preferred embodiments of the invention without departing substantially from the spirit and principles of the invention. All such modifications and variations are intended to be included herein within the scope of the present invention, as defined by the following claims.

I claim:

1. A centrifuge rotor comprising
a) a first centrifuge rotor part and a second centrifuge rotor part which can be mounted with each other and which in a mounted state delimit an inner chamber in which a product to be centrifuged can be arranged,
b) wherein the first centrifuge rotor part and the second centrifuge rotor part are connected to each other by a locking device,
c) the locking device arranged at a distance from a rotor axis of the centrifuge rotor and comprising a first locking element and a second locking element,
d) the first locking element comprises a locking pin fixed to the first centrifuge rotor part, the locking pin comprising a locking protrusion and
e) the second locking element comprises a locking carriage and a sliding guide which is fixed to the second centrifuge rotor part and which guides the locking carriage relative to the second centrifuge rotor part for a radial displacement for being moved in radial direction, the locking carriage being moved from an unlocking position into a locking position by a centrifugal force caused by a rotation of the centrifuge rotor,
f) the locking carriage comprises an elongated hole, the elongated hole comprising a locking section and an unlocking section,
a width of the elongated hole in the unlocking section being greater than a width of the locking protrusion of the locking pin so that the locking protrusion of the locking pin is able to pass through the unlocking section of the elongated hole and
a width of the elongated hole in the locking section being smaller than the width of the locking protrusion of the locking pin so that the locking protrusion of the locking pin is not able to pass through the unlocking section of the elongated hole,
g) in the assembled state the locking pin extends through and out of the elongated hole of the locking carriage,
h) in the locking position of the locking carriage a first contact surface of the locking protrusion of the locking pin contacts a second contact surface of the looking carriage arranged at the locking section of the elongated hole, the first and second contact surfaces providing a positive fit which blocks a disassembly of the first and second centrifuge rotor parts from each other.

2. The centrifuge rotor of claim 1, wherein at least two locking devices are evenly distributed in a circumferential direction around the rotor axis of the centrifuge rotor and are arranged at the same distance from the rotor axis.

3. The centrifuge rotor of claim 1, wherein in the mounted state of the first centrifuge rotor part and the second centrifuge rotor part and in the locking position of the locking carriage at least one of the locking carriage and the second centrifuge rotor part is trapped between the first contact surface of the locking protrusion of the locking pin and the first centrifuge rotor part.

4. The centrifuge rotor of claim 1, wherein the locking carriage comprises an L-shaped sliding piece.

5. The centrifuge rotor of claim 1, wherein at least one of the first and second contact surfaces is inclined relative to a plane oriented transverse to the rotor axis such that a centrifugal force acting on the locking carriage is converted by the first or second contact surface into a contact force by which the first centrifuge rotor part and the second centrifuge rotor part are pressed against one another.

6. The centrifuge rotor of claim 1, wherein the locking carriage comprises a manual actuation means, by means of which the locking carriage can be moved manually from the locking position into the unlocking position and/or from the unlocking position into the locking position.

7. The centrifuge rotor of claim 4, wherein one leg of the L-shaped sliding piece forms a manual actuation means, by means of which the locking carriage can be moved manually from the locking position into the unlocking position and/or from the unlocking position into the locking position.

8. The centrifuge rotor of claim 1, wherein a securing device is provided, by means of which the locking carriage can be secured in the unlocking position and/or the locking position.

9. The centrifuge rotor of claim 8, wherein the securing device is released by a centrifugal force acting on the locking carriage.

10. The centrifuge rotor of claim 9, wherein the securing device is a magnetic securing device.

11. The centrifuge rotor of claim 1, wherein the locking carriage comprises a component of a sensor.

12. The centrifuge rotor of claim 11, wherein the sensor senses
a) whether the locking carriage is in the locking position or in the unlocking position and/or
b) the movement of the locking carriage as a result of its rotation with the centrifuge rotor.

13. A centrifuge with a centrifuge rotor comprising
a) a first centrifuge rotor part and a second centrifuge rotor part which can be mounted with each other and which in a mounted state delimit an inner chamber in which a product to be centrifuged can be arranged,
b) wherein the first centrifuge rotor part and the second centrifuge rotor part are connected to each other by a locking device,
c) the locking device arranged at a distance from a rotor axis of the centrifuge rotor and comprising a first locking element and a second locking element,
d) the first locking element comprises a locking pin fixed to the first centrifuge rotor part, the locking pin comprising a locking protrusion and
e) the second locking element comprises a locking carriage and a sliding guide which is fixed to the second centrifuge rotor part and which guides the locking carriage relative to the second centrifuge rotor part for a radial displacement for being moved in radial direction, the locking carriage being moved from an unlocking position into a locking position by a centrifugal force caused by a rotation of the centrifuge rotor,
f) the locking carriage comprises an elongated hole, the elongated hole comprising a locking section and an unlocking section,
a width of the elongated hole in the unlocking section being greater than a width of the locking protrusion of the locking pin so that the locking protrusion of the locking pin is able to pass through the unlocking section of the elongated hole and
a width of the elongated hole in the locking section being smaller than the width of the locking protrusion of the locking pin so that the locking protrusion of the locking pin is not able to pass through the unlocking section of the elongated hole,
g) in the assembled state the locking pin extends through and out of the elongated hole of the locking carriage,
h) in the locking position of the locking carriage a first contact surface of the locking protrusion of the locking pin contacts a second contact surface of the looking carriage arranged at the locking section of the elongated hole, the first and second contact surfaces providing a positive fit which blocks a disassembly of the first and second centrifuge rotor parts from each other.

14. The centrifuge of claim 13, wherein the centrifuge is a laboratory centrifuge.

15. The centrifuge of claim 13, wherein the centrifuge is a passing flow centrifuge.

16. The centrifuge of claim 13, wherein the centrifuge comprises a control unit with control logic configured for
determining an imbalance of the centrifuge rotor and
evaluating on the basis of the detected imbalance whether the locking carriage is in the locking position.
